(19) United States
(12) Patent Application Publication
(10) Pub. No.: US 2004/0075001 A1
(43) Pub. Date: Apr. 22, 2004

(54) Fuel injection valve

(76) Inventors: Volker Holzgrefe, Ditzingen (DE); Gunther Hohl, Stuttgart (DE); Michael Hubel, Gerlingen (DE); Jurgen Stein, Illingen (DE)

Correspondence Address: KENYON & KENYON, ONE BROADWAY, NEW YORK, NY, 10004, US

(21) Appl. No.: 10/450,963

(22) PCT Filed: Aug. 22, 2002
(86) PCT No.: PCT/DE02/03073

(30) Foreign Application Priority Data
Oct. 24, 2001 (DE) 101 52 415.3

(51) Int. Cl. B05B 1/30

(52) U.S. Cl. 239/585.1

(57) ABSTRACT

A fuel injector (1) for the injection of fuel into the combustion chamber of an internal combustion engine includes a valve needle (4) guided in a nozzle body (3), the valve needle (4) being actuable by an actuator (7) and acted upon by a restoring spring (9) in such a manner that a valve-closure member (5) which is in operative connection to the valve needle (4) is retained in sealing contact against a valve-seat surface (6). Formed at a downstream-side end (13) of the fuel injector (1) is a projection (14) which projects beyond the valve-closure member (5) of the fuel injector (1).

### BACKGROUND INFORMATION

The present invention is based on a fuel injector of the type set forth in the main claim.

For instance, from DE 195 34 445 A1, an outwardly opening fuel injector is known which has a conical sealing seat. The valve needle has a central bore which leads into a pressure chamber located upstream from the sealing seat. An actuator, which is embodied as a piezoelectric actuator, on one side is braced against a nozzle body and on the other side against a pressure shoulder which is connected to the valve needle by force-locking. A restoring spring keeps the valve needle in a closing position. In response to the actuator being energized, the valve needle, due to the actuator's longitudinal expansion, is opened against the closing force of the restoring spring and fuel is spray-discharged.

Disadvantageous in the fuel injector known from DE 195 34 445 A1 is, in particular, that the fuel jet injected into the combustion chamber of the internal combustion engine has a conical shape and is symmetrical to a longitudinal axis of the fuel injector. A slanted injection and an asymmetrical deformation of the conical jet, to compensate for a tight fitting position of the fuel injector, for instance, is not possible here.

### SUMMARY OF THE INVENTION

In contrast, the fuel injector according to the present invention, having the characterizing features of the main claim, has the advantage over the related art that a slanted injection at any desired angle V and a selected deformation of the injected mixture cloud are possible by simple measures with regard to the contour of the nozzle body.

This is realized by a projection which surrounds the sealing seat, in part or completely, and which may be adapted according to the demands on form and direction of the fuel jet.

Advantageous further developments of the fuel injector specified in the main claim are rendered possible by the measures elucidated in the dependent claims.

The projection advantageously has an annular design and includes a recess whose longitudinal axis is tilted with respect to a longitudinal axis of the fuel injector. Any desired injection angle may be realized by a more or less pronounced tilting of the axes with respect to each another.

Furthermore, it is advantageous that the projection may also be embodied in the form of one or a plurality of nipples which deform the mixture cloud in a desired manner.

The projection or the nipples are formed in a simple manner either integrally with the nozzle body or are affixed thereto using suitable technology, such as welding or soldering.

### BRIEF DESCRIPTION OF THE DRAWINGS

Exemplary embodiments of the present invention are shown in simplified form in the drawing and are elucidated in greater detail in the following description.

The figures show:

FIG. 1 a schematic section through a first exemplary embodiment of a fuel injector configured according to the present invention;

FIG. 2 a schematic section through a second exemplary embodiment of a fuel injector configured according to the present invention;

FIG. 3 a schematic cut-away portion of the exemplary embodiment of a fuel injector configured according to the present invention shown in FIG. 2, in region III in FIG. 2, in a rotated view; and

FIG. 4 a schematic representation of a mixture cloud injected into the combustion chamber using the fuel injector configured according to the present invention, as represented in FIGS. 2 and 3.

### DESCRIPTION OF THE EXEMPLARY EMBODIMENTS

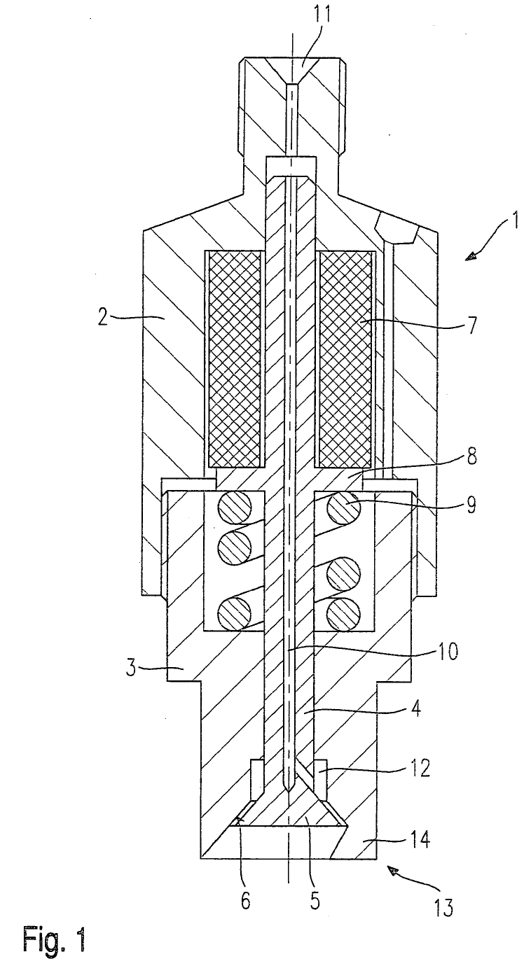

A first exemplary embodiment of a fuel injector 1 according to the present invention, shown in FIG. 1, is designed in the form of a fuel injector 1 for fuel-injection systems of mixture-compressing internal combustion engines having externally supplied ignition. Fuel injector 1 is particularly suited for the direct injection of fuel into a combustion chamber (not shown) of an internal combustion engine.

Fuel injector 1 includes a housing body 2 and a nozzle body 3, in which a valve needle 4 is positioned. Valve needle 4 is in operative connection to a valve-closure member 5 which cooperates with a valve-seat surface 6 to form a sealing seat. The fuel injector in the exemplary embodiment is an outwardly opening fuel injector 1. It includes an actuator 7 which is embodied as a piezoelectric actuator 7 in the exemplary embodiment. On one side, the actuator is braced on housing body 2, and on the other side on a shoulder 8 which is in operative connection to valve needle 4. Downstream from shoulder 8 is a restoring spring 9 which in turn is braced on nozzle body 3.

Valve needle 4 has a fuel channel 10 through which the fuel, conveyed through an inflow-side central fuel feed 11, is guided to the sealing seat. On the inflow side of the sealing seat, a swirl chamber 12 is formed into which fuel channel 10 opens.

In the rest state of fuel injector 1, the force of restoring spring 9 acts upon shoulder 8 counter to the lift direction, in such a way that valve-closure member 5 is retained in sealing contact against valve-seat surface 6. In response to piezoelectric actuator 7 being energized, it expands in the axial direction, counter to the spring force of restoring spring 9, so that shoulder 8 with valve needle 4, which is joined to shoulder 8 by force-locking, is moved in the lift direction. Valve-closure member 5 lifts off from valve-seat surface 6, and the fuel conveyed via fuel channel 10 is spray-discharged.

When the energizing current is switched off, the axial expansion of piezoelectric actuator 7 is reduced, so that the pressure of restoring spring 9 moves valve needle 4 counter to the lift direction. Valve closure member 5 sets down on valve-seat surface 6, and fuel injector 1 is closed.

According to the present invention, fuel injector 1, at a discharge-side end 13, has a projection 14 which encloses valve-closure member 5 at least partially. In the present first exemplary embodiment, projection 14 is designed such that it encloses valve-closure member 5 in its entirety and, in doing so, forms an annular structure. Projection 14 has a recess 18 whose longitudinal axis 19 is tilted relative to a longitudinal axis 20 of fuel injector 1. By such a design of projection 14, an angle γ defining the spray-discharge direction of fuel injector 1 may be adjusted as desired. Fuel injectors 1 having slanted injection are important especially in those instances where the installation space is limited or when a spark plug, which must not be exposed to direct injection, is located in the immediate vicinity of fuel injector 1.

Recess 18 has a slanted conical shape in the exemplary embodiment and widens toward the combustion chamber.

Projection 14 may be integrally formed with the discharge-side end 13 or with nozzle body 3 of fuel injector 1, as shown in the first exemplary embodiment, or it may be affixed retroactively using a suitable technology such as soldering or welding.

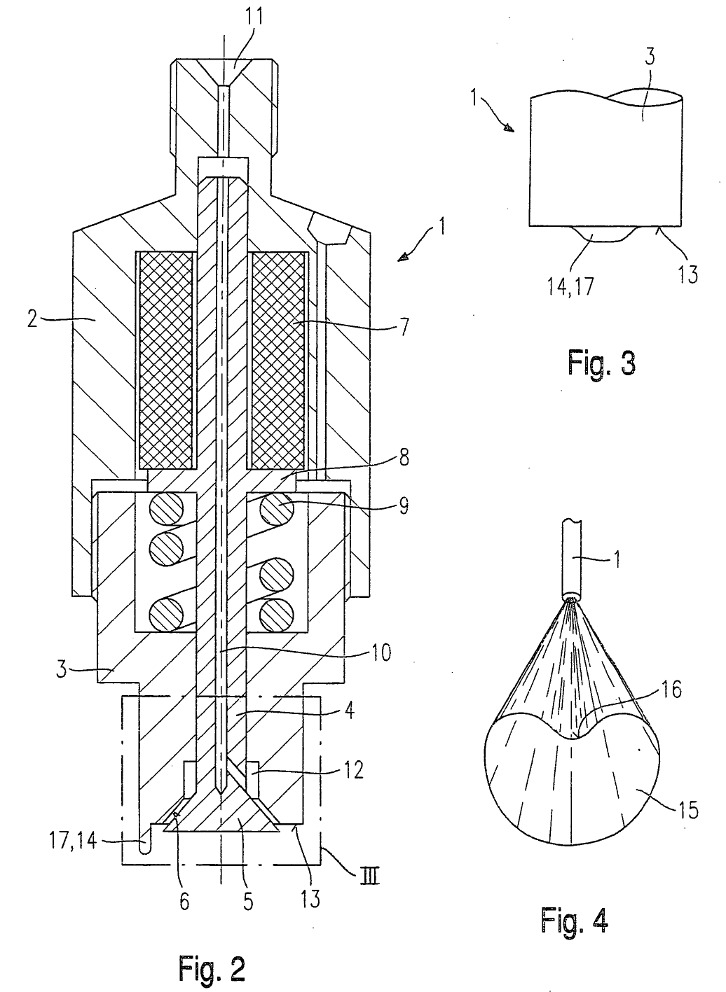

In a sectional view, FIG. 2 shows a second exemplary embodiment of a fuel injector 1 configured according to the present invention. Identical components bear the same reference numerals. With the exception of the measures of the present invention, fuel injector 1 in the second exemplary embodiment may have a design that is identical to that in the first exemplary embodiment, so that a repetitious description of already discussed components may be dispensed with.

In the present second exemplary embodiment, projection 14, which forms an annular structure in the first exemplary embodiment, is now embodied in the form of a nipple 17 in only one spot on the downstream-side end 13 of fuel injector 1. By a suitable selection of the axial length and the angular range covered by nipple 17, it is possible to deform the mixture cloud injected into the combustion chamber of the internal combustion engine.

In FIG. 3, the downstream-side end 13 of fuel injector 1 according to the cut-away portion designated III in FIG. 2, is represented in a view rotated by 90°, thereby showing the extension of nipple 17 more clearly. Nipple 17 may either be integrally formed with nozzle body 3 or retroactively affixed thereto by means of welding or soldering.

FIG. 4 shows a mixture cloud 15 which is injected into the combustion chamber of the internal combustion engine using fuel injector 1 shown in the exemplary embodiment in FIG. 2. Due to the shielding effect of nipple 17, mixture cloud 15 has a dent 16 in this region, which may, for instance, be arranged in such a way that a spark plug adjacent to fuel injector 1 is not directly exposed to injected fuel, thereby reducing the coking of the spark plug.

Mixture cloud 15 may also be deformed further by positioning a plurality of nipples 17 at arbitrary points on the spray-discharge side end 13 of fuel injector 1, for instance when a plurality of spark plugs is present or the position of the intake and discharge valve seems to require this.

The present invention is not limited to the exemplary embodiments shown, but applicable to electromagnetically actuable fuel injectors 1 as well.

What is claimed is:

1. A fuel injector (1) for the direct injection of fuel into the combustion chamber of an internal combustion engine, having a valve needle (4) situated in a nozzle body (3), the valve needle (4) being actuable by an actuator (7) and acted upon by a restoring spring (9) in such a manner that a valve-closure member (5) which is in operative connection to the valve needle (4) and faces the combustion chamber is retained in sealing contact against a valve-seat surface (6) in the non-actuated state of the actuator (7),
wherein, at a downstream-side end (13) of the fuel injector (1), a projection (14) is formed that projects beyond the valve-closure member (5).

2. The fuel injector as recited in claim 1,
wherein the projection (14) surrounds the valve-closure member (5) at least partially.

3. The fuel injector as recited in claim 2,
wherein the projection (14) has an annular design.

4. The fuel injector as recited in claim 3,
wherein the projection (14) has a recess (18) whose longitudinal axis (19) is tilted at an angle (γ) relative to a longitudinal axis (20) of the fuel injector (1).

5. The fuel injector as recited in claim 4,
wherein the recess (18) has a conical design and widens towards the combustion chamber.

6. The fuel injector as recited in claim 1,
wherein the projection (14) is realized in the form of at least one nipple (17).

7. The fuel injector as recited in claim 6,
wherein the at least one nipple (17) deforms the shape of a mixture cloud (15) injected into the combustion chamber in such a way that at least one dent (16) occurs in the mixture cloud (15).

8. The fuel injector as recited in one of the claims 1 through 7,
wherein the projection (14; 17) is integrally formed with the nozzle body (3) of the fuel injector (1).

9. The fuel injector as recited in one of claims 1 through 7,
wherein the projection (14; 17) is affixed to the downstream-side end (13) of the fuel injector (1).
